(19) United States
(12) Patent Application Publication
(10) Pub. No.: US 2005/0289288 A1
(43) Pub. Date: Dec. 29, 2005

(54) Compression and decompression of expansion read only memories

(76) Inventors: David L. Matheny, Cedar Park, TX (US); Navneet Malpani, Austin, TX (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/877,763

(22) Filed: Jun. 25, 2004

(51) Int. Cl. G06F 12/00

(52) U.S. Cl. 711/102; 713/2; 711/154

(57) ABSTRACT

The inventive subject matter provides systems, methods, data structures, and software to compress and decompress a memory image such as an expansion read-only memory (ROM). Some embodiments include attaching a compressed memory image to a decompression shell to create a data structure that includes decompression instructions. Other embodiments include loading a memory image from a data structure by decompressing the memory image according to decompression instructions included in the data structure.

### TECHNICAL FIELD

The inventive subject matter relates to the boot environment of computers and, more particularly, to expansion Read Only Memory (ROM) compression and decompression.

### BACKGROUND INFORMATION

Expansion Read Only Memories (ROMs), also known as option ROMs, typically have very slow access times. A technique used to increase access time is to create a shadow ROM by copying the expansion ROM into a block of higher speed Random Access Memory (RAM) when booting a system. All subsequent access to that ROM is routed to the RAM, although writes are typically blocked after the initial copy phase.

However, despite an increase in available memory in computers today, the amount of memory available in the pre-boot environment has remained largely unchanged. This lack of memory is further compounded by a lack of enforced standards in the pre-boot environment. For example, many basic input/output systems (BIOS) do not support loading a ROM larger than 64 kilobytes (KB). Thus, developers and device manufacturers cannot count on pre-boot environment memories of more than 64 KB. This puts even more size pressure on expansion ROMs while the contents of the expansion ROMs are providing an ever-increasing feature set.

### BRIEF DESCRIPTION OF THE DRAWINGS

FIG. 1 is a schematic of a system according to an example embodiment of the inventive subject matter.

FIG. 2A is diagram of a data structure according to an example embodiment of the inventive subject matter.

FIG. 2B is diagram of a data structure according to an example embodiment of the inventive subject matter.

FIG. 3 is a flow diagram of a method according to an example embodiment of the inventive subject matter.

FIG. 4 is a flow diagram of another method for generating a compressed memory image according to an example embodiment of the inventive subject matter.

FIG. 5 is a flow diagram of a method according to an example embodiment of the inventive subject matter.

FIG. 6 is a flow diagram of a method according to an example embodiment of the inventive subject matter.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in an embodiment. The software comprises computer-executable instructions stored on computer-readable media such as memory or other type of storage devices. The term “computer-readable media” is also used to represent carrier waves on which the software is transmitted. Further, such functions correspond to modules, which are software, hardware, firmware, or any combination thereof. Multiple functions may be performed in one or more modules as desired, and the embodiments described are merely examples. The software is executed on a digital signal processor, ASIC (Application-Specific Integrated Circuit), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Some embodiments, as described below, include reference to Read Only Memories (ROMs). These references are intended to reflect only the purpose of the referenced memories and not the actual, physical type of memory. The actual, physical type of these memories varies depending on the specific embodiment and requirements and other factors therein. In some embodiments, the ROM is a random access memory (RAM) that is write-protected. In yet other embodiments, the ROM is a non-volatile memory such as a flash memory. Yet other embodiments include various other physical types of memory. Thus, the use of the term ROM herein is not intended to limit the type of memory used or described in a particular embodiment.

### System Overview

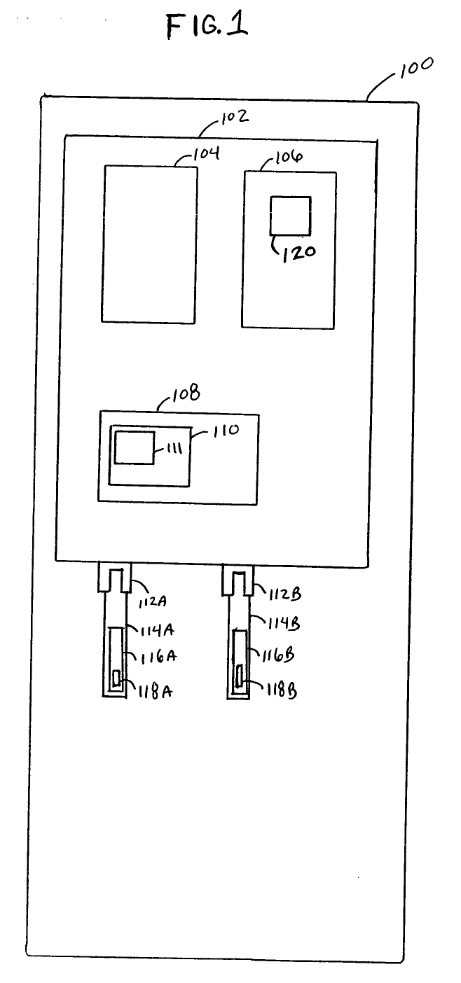

FIG. 1 is a schematic of a system 100 according to an example embodiment of the inventive subject matter. Some embodiments of the system 100 are capable of utilizing devices having compressed expansion ROMs. Other embodiments of the system 100 are capable of compressing a memory image for use in an expansion ROM. Yet further embodiments of the system are capable of compressing a memory image for use in an expansion ROM and capable of utilizing devices having compressed expansion ROMs.

The elements of the illustrated example system 100 include a motherboard 102 having a processor 104, a memory 106, an integrated peripheral device 108, and expansion slots 112A and 112B. In some embodiments, the system 100 comprises a personal computer such as a desktop or laptop computer. In other embodiments, the system 100 comprises a networked server computer. In yet other embodiments, the system 100 comprises a handheld computing device such as a personal digital assistant (PDA) or a wireless telephone. Yet further embodiments include other systems and devices that can benefit from a compressed memory image, such as a compressed ROM including instructions for initializing and operating the system or device.

In some embodiments, the motherboard 102 includes circuitry for the processor 104, circuitry for one or more input devices such as a keyboard or mouse, and circuitry for video output devices. The motherboard further includes expansion slots 112A and 112B to accept additional circuitry. Some embodiments include more than two expansion slots, while other embodiments do not include expansion slots. In some further embodiments, the motherboard 102 includes integrated circuitry, such as an integrated peripheral device 108.

The processor 104 of the example system 100 may represent a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. The processor 104 executes instructions. In some embodiments, the processor 104 also includes a control unit that organizes data and program storage in memory 106 and transfers data and other information in and out of the system 100.

The memory 106 represents one or more mechanisms to store data. For example, the memory 106, in various embodiments, includes one or more of a read only memory (ROM), random access memory (RAM), magnetic disk storage media, optical storage media, flash memory devices, and/or other volatile and non-volatile machine-readable media. In other embodiments, any appropriate type of storage device or memory 106 can be used. Although only one memory 106 is shown, multiple memories 106 and multiple types of storage devices can be present.

In some embodiments, the integrated peripheral device 108 comprises a graphics card, a Small Computer System Interface (SCSI) controller, a modem, a Network Interface Card (NIC), or virtually any other peripheral device integrated onto a motherboard 102. In these embodiments, the integrated peripheral device includes one or more memories 110, such as an expansion ROM or a RAM, having instructions 111 stored thereon for performing various tasks according to the inventive subjection matter. Some such tasks include storing instructions 111 operable on the processor 104 for decompressing a compressed memory image. In some such embodiments, the compressed memory image is also stored in the memory 110. In some other embodiments, the compressed memory image is a portion of the instructions 111.

In some embodiments, the expansion cards 114 comprise Peripheral Component Interconnect (PCI) cards or an Advanced Graphics Port (AGP) card. Some example PCI cards include Small Computer System Interface (SCSI) controller cards, modems, network interface cards (NIC), audio cards, and virtually any other peripheral device card depending on the requirements for a specific embodiment. In these embodiments, the PCI cards 114A and 141B both include one or more memories 116A and 161B, such as an expansion ROM or a RAM, having instructions 118A and 181B stored thereon for performing various tasks according to the inventive subjection matter. Some such tasks include storing instructions 118A and 181B operable on the processor 104 for decompressing a compressed memory image. In some embodiments, the compressed memory image is also stored in the memory 116A and 161B. In other embodiments, the compressed memory image is a portion of the instructions 118A and 118B.

In some embodiments, the memory 106 includes instructions 120 for building a data structure for holding a compressed memory image of a device, such as integrated device 108 or device 114A. In some embodiments, the instructions include decompression instructions attached to the data structure for use by the processor 104 in decompressing a compressed memory image. In some embodiments, the compressed memory image is an instruction set for initializing and operating a peripheral device, such as a PCI, AGP, or other device. In some embodiments, the data structure is built to fit in a device memory, such as a flash memory or other memory on a device. In some such embodiments, the memory size available to store the data structure is no larger than 64 KB.

### Data Structure Overview

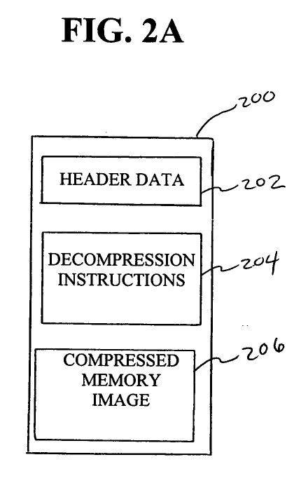

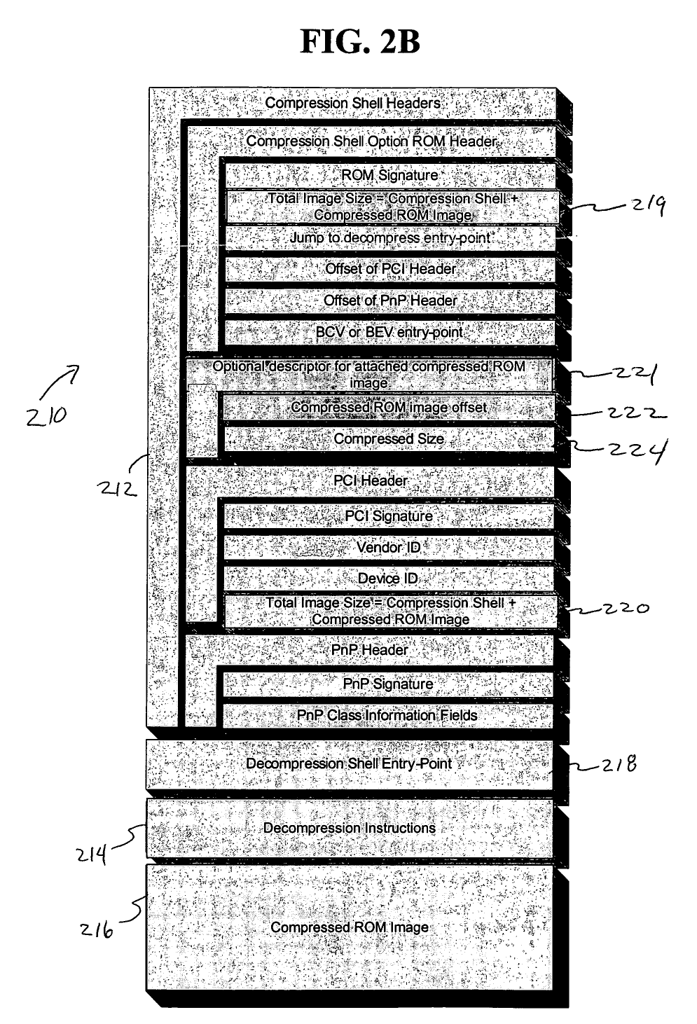

FIG. 2A is diagram of a data structure 200 according to an example embodiment of the inventive subject matter. In some embodiments, the data structure 200 includes three components. These components include header data 202, decompression instructions 204, and a compressed memory image 206.

The headers 202 contain descriptive data of the data structure 200. This descriptive data is useful for several purposes, one of which is for use in determining if the data structure has been tampered with or has otherwise become corrupt. In some embodiments, the descriptive data includes size data indicating the size of the data structure. In some further embodiments, the data structure also includes a checksum value. In some embodiments, a determination can be made if the data structure has been corrupted by summing all of the bytes of the data structure including the checksum value. If the value equals zero, the data structure is not corrupt.

The decompression instructions 204 include instructions for decompressing the compressed memory image 206. The memory image 206 is compressed according to a data compression algorithm. The decompression instructions 204 are instructions for processing the compressed memory image according to the same compression algorithm used to compress the memory image 206. In some embodiments, the compression algorithm is the zlib algorithm. (See http://www-gzip-org/zlib/). In other embodiments, the compression algorithm is the gzip algorithm. (See http://www-gzip-org/). (To avoid inadvertent hyperlinks, the periods in the preceding URLs have been replaced by hyphens.) In yet further embodiments, other data compression algorithms are used.

In another embodiment, not shown, the data structure includes only header data and the compressed memory image. In this embodiment, when the expansion ROM contents are read by a system BIOS, the BIOS does not need the decompression instructions, because the BIOS knows where to obtain the decompression instructions elsewhere within the BIOS or in another location within the system.

FIG. 2B is diagram of a data structure 210 according to an example embodiment of the inventive subject matter. This embodiment also includes three components. These components include compression shell headers 212, decompression instructions 214, and a compressed ROM image 216. Some embodiments of this data structure 210 also include a decompression shell entry-point 218.

The compression shell headers 212 include several items of data as illustrated. These headers are generally a copy of the headers from the ROM image prior to compression. After the data structure 210 is built, some of these data items are updated. For example, the checksum (not shown) and total image size=compression shell+total image size 219 and 220 are updated. Some further embodiments include optional descriptors for the attached compressed ROM image 221. This optional portion of the compression shell headers 212 includes a compressed ROM image offset 222 indicating where the compressed ROM image begins in the data structure 210. Also included in this optional portion is a compressed size 224 portion providing data about the compressed size of the compressed ROM image 216.

The decompression instructions 214 portion of the data structure 210 includes instructions for decompressing the compressed ROM image 216. The compressed ROM image 216 is generally compressed according to a data compression algorithm. In an embodiment, the decompression instructions 214 are computer-executable instructions for processing the compressed ROM image 216 according to the same compression algorithm used to compress the ROM image 216. In some embodiments, various data compression algorithms are used as described above.

Some embodiments of the data structure 210 include a decompression shell entry point 218 field. This field tells the BIOS where the entry point is to start decompressing the compressed ROM image 216.

### Building the Data Structure and Compressing the Memory Image

Some embodiments of the inventive subject matter include building one or more data structures, such as data structures 200 and 210 of FIG. 2A and FIG. 2B, for holding compressed expansion ROM images. When building such a data structure, some embodiments require building it in such a way that the new ROM headers look just like the original headers so the headers can be loaded for the proper device by the BIOS. The differences may include the size, checksum, and entry-point fields. In some embodiments, it is also convenient to add custom fields that specify the offset of the compressed ROM image or possibly the length of the compressed ROM image. However, such information is obtainable in some embodiments without adding custom fields, but it does not hurt anything to do so and it can make the decompression more convenient or efficient.

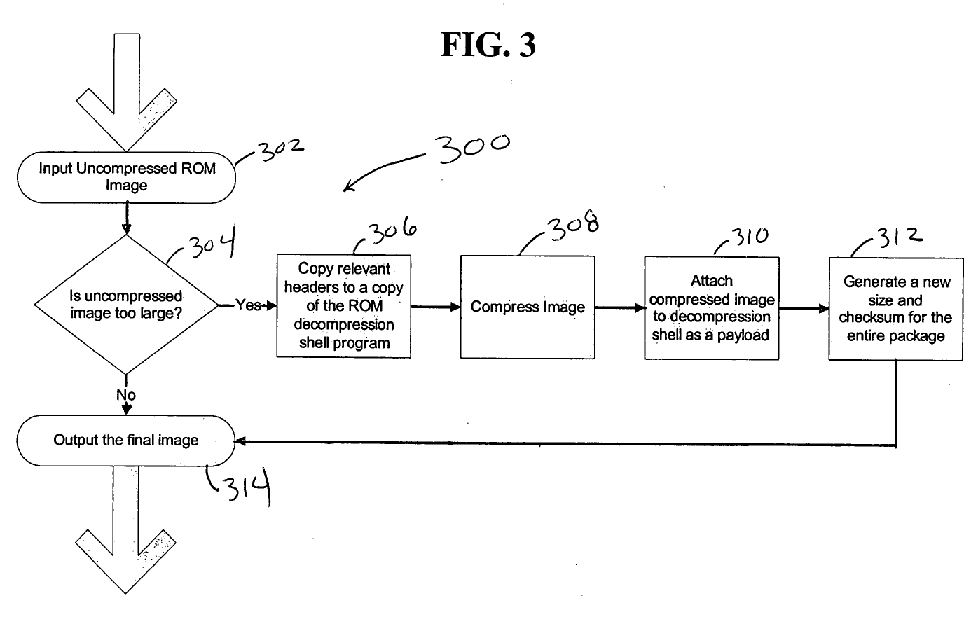

FIG. 3 illustrates a flow diagram of a method 300 according to an example embodiment of the inventive subject matter. The method 300 includes inputting an uncompressed memory image 302 and determining if the uncompressed image is too large to fit in a target memory 304, such as an expansion ROM of a peripheral device. If the uncompressed memory image is not larger than the area available in the target memory, the method 300 outputs the uncompressed memory image as the final image 314. However, if the uncompressed memory image is larger than the space available in the target memory, the uncompressed image is further processed. In many embodiments, the threshold size is 64 KB.

The input uncompressed ROM image 302 is further processed by copying relevant headers from within the ROM image to a copy of a decompression shell program 306. In some embodiments, the decompression shell program includes instructions or code for decompressing a compressed ROM image. Examples of such a decompression shell program are described above with regard to reference numbers 204 and 214 in FIG. 2A and FIG. 2B, respectively.

In some embodiments, the ROM image is then compressed 308 and attached to the decompression shell 310. The method 300, has to this point, assembled a data structure including the copied headers 306, the compressed ROM image 308, and the decompression shell program. Examples of such a data structure are discussed above with regard to data structures 200 and 210 in FIG. 2A and FIG. 2B, respectively.

This embodiment of the method 300 then proceeds by updating the header data. In some embodiments updating the header data includes generating a new size and checksum 312 for the copied headers. The data structure is then output as the final image 314.

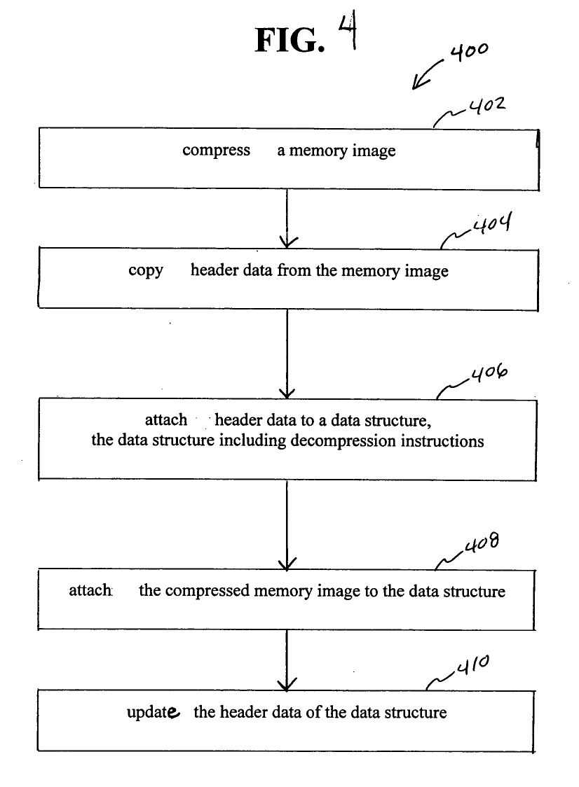

FIG. 4 is a flow diagram of another method 400 for generating a compressed memory image according to an example embodiment of the inventive subject matter. The method 400 includes compressing a memory image 402, copying header data from memory image 404, and attaching the copied header data to a data structure that includes decompression instructions 406. The method 400 further includes attaching the compressed memory image to the data structure 408 and updating the header data of the data structure 410. In this embodiment, updating the header data of the data structure 410 includes updating, expanding, or adding one or more fields of header data. In some embodiments, these fields of header data include a checksum field, a file size field for the data structure or a portion thereof, additional header data fields, or virtually any other header data field relevant to a particular embodiment of the inventive subject matter.

### Decompressing the Memory Image

Once a compressed data structure has been created and placed in a device expansion ROM, the expansion ROM is loadable by a system BIOS. The BIOS sees the entire data structure as a single expansion ROM and copies it directly into available upper memory, such as an upper memory bank or shadow-RAM). Once the expansion ROM has been mapped into upper memory, the BIOS may make a far jump to offset, three for example, in the BIOS image which allows the decompression instructions to take over execution. The expansion ROM header for the decompression shell contains a jump or call to the point where execution should begin.

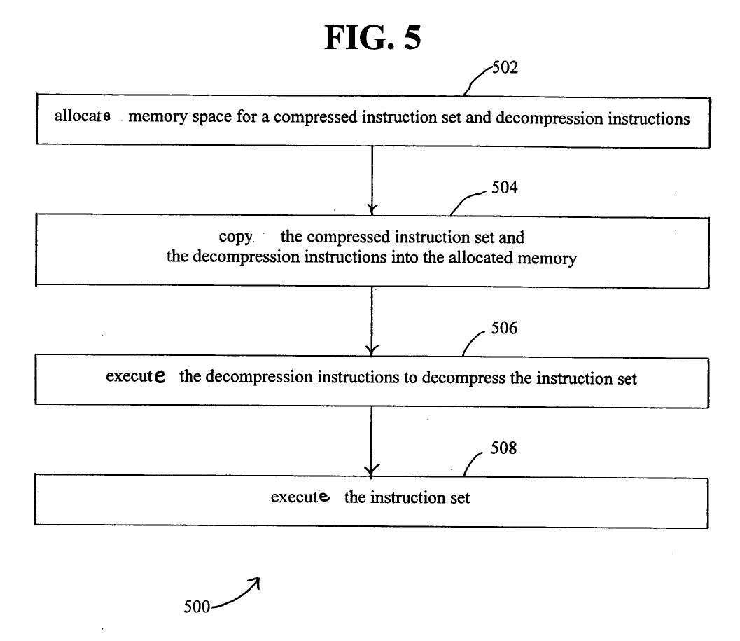

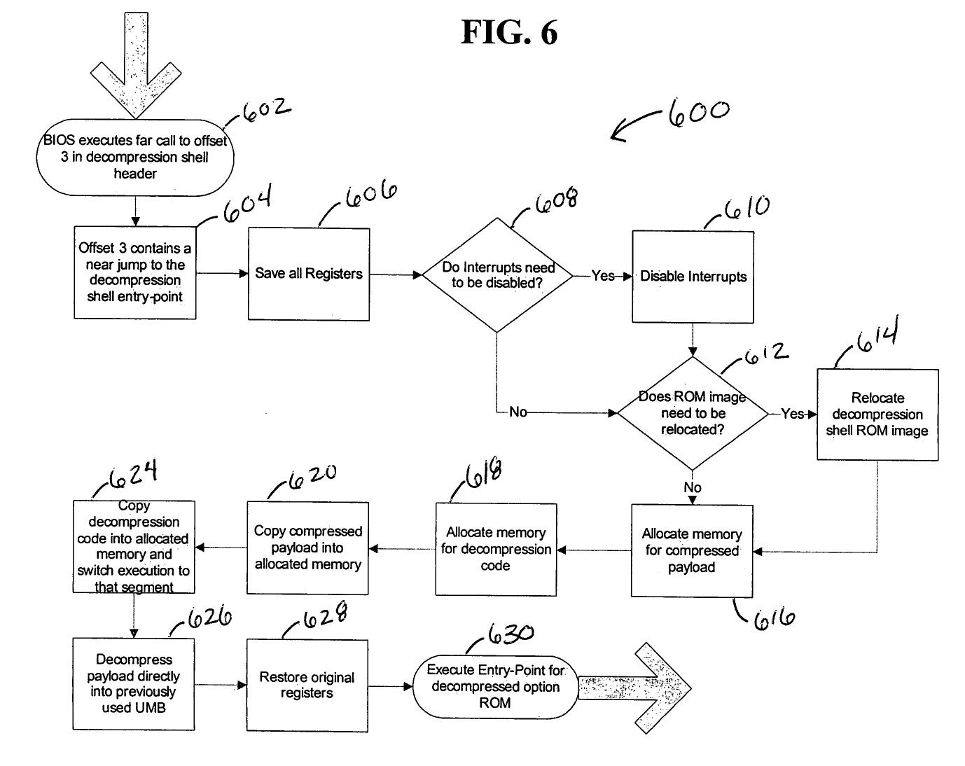

In some embodiments, when the decompression instructions receive control, the instructions execute to cause a data structure, such as data structure 200 of FIG. 2A or data structure 210 of FIG. 2b, to be copied into a higher speed, larger memory such as a system RAM. The decompression instructions further cause the compressed memory image to be inflated and executed. Two such example embodiments are illustrated in FIG. 5 and FIG. 6.

FIG. 5 is a flow diagram of a method 500 according to an example embodiment of the inventive subject matter. This method includes allocating memory space for a compressed instruction set, such as a compressed ROM image, and decompression instructions 502. The method 500 further includes copying the compressed instruction set and the decompression instructions into the allocated memory 504 and executing the decompression instructions to decompress the instruction set 506. Some embodiments also include executing the decompressed instruction set 508.

FIG. 6 is a flow diagram of a method 600 according to an example embodiment of the inventive subject matter. The method 600 begins with the BIOS executing a call to offset 3 in the decompression shell header 602, which contains a near jump to the decompression shell entry-point 604. This places execution of the method 600 at the location in the decompression shell where the instructions begin. The method 600 continues by saving a backup of all registers 606. In some embodiments, saving a backup of all registers 606 includes saving only the registers involved in the processing of the decompression shell. In some embodiments, saving all of the registers 606 includes saving the flags register so they can subsequently be passed directly to the attached extension ROM once it has been decompressed.

The method 600 then determines if the interrupts need to be disabled 608. If the interrupts need to be disabled, they are 610. In some embodiments, disabling the interrupts is recommended if conventional scratch memory is going to be used to decompress the attached extension ROM.

The method 600 continues by determining whether the compressed ROM image needs to be relocated 612. This determination is based on the method, or call, needed to read the compressed ROM image from memory. If far segments are necessary to read the compressed ROM image from memory, the compressed ROM image is relocated 614 to permit reading the image from memory using a near call.

Next, the method 600 allocates memory for the compressed ROM image 616 in memory. Some embodiments include allocating a temporary buffer in conventional memory or using extended memory through a mechanism such as the Post Memory Manager (PMM). Memory is then allocated for the decompression instructions 618. The compressed ROM image is then copied into the allocated memory 620. The decompression instructions are then copied into the allocated memory and execution is switched to the decompression instructions 624. Switching execution to the newly allocated instruction segment frees the allocated upper memory so that it is no longer being used by the method 600.

In some embodiments, the compressed ROM image is then decompressed directly into the previously used upper memory block 626. Once the ROM has been completely decompressed, the registers are restored 628 from the saved copy of the registers 606. The newly decompressed ROM image's entry-point is then called 630 with all the original register intact.

In some embodiments, the memory that was allocated for the compressed ROM image and decompression instructions should no longer be reserved after the decompressed ROM image has been called. In some such embodiments, if this memory is not yet unallocated, it must be expressly unallocated.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

1. A method comprising:
compressing a memory image;
copying header data from the memory image;
attaching the header data and the compressed memory image to a data structure that includes decompression instructions; and
updating the header data of the data structure.

2. The method of claim 1, wherein the decompression instructions, when executed, decompress the memory image.

3. The method of claim 1, wherein the memory image is compressed according to a data compression algorithm.

4. The method of claim 1, wherein the data compression algorithm comprises a zlib compression algorithm.

5. The method of claim 1, wherein updating the header data of the data structure includes updating a size and a checksum.

6. The method of claim 1, wherein the memory image comprises a data image to store in a memory providing instructions to a portion of a computer when booted.

7. The method of claim 6, wherein the memory comprises a read-only memory.

8. A system comprising:
a memory having instructions to initialize and operate a device, the instructions stored in a data structure assembled by:
compressing the instructions into the data structure, the data structure also including decompression instructions,
copying header data from the instructions and attaching the header data to the data structure, and
updating a size value and a checksum value in the header data.

9. The system of claim 8, wherein the device comprises a computer peripheral card.

10. The system of claim 8, wherein the memory comprises a read only memory.

11. The system of claim 8, wherein the instructions are executable to initialize and operate the device are copied to and executed from a random access memory.

12. A method comprising:
attaching a compressed memory image to a decompression shell to create a data structure, wherein the attaching includes copying header data from the memory image and updating a checksum portion and a size portion of the header data; and
loading the compressed memory image from the data structure by decompressing the compressed memory image according to the decompression shell.

13. The method of claim 12, wherein the decompression shell includes instructions to decompress the compressed data.

14. The method of claim 12, wherein the memory image is compressed according to a compression algorithm.

15. The method of claim 14, wherein the compression algorithm comprises a zlib algorithm.

16. An article comprising a machine-accessible medium having associated data, wherein the data, when accessed, result in a machine performing:
attaching a compressed memory image to a decompression shell to create a data structure;
writing a header of the data structure to match header data of the memory image; and
updating a portion of the header data.

17. The article of claim 16, wherein updating a portion of the header data includes updating a checksum portion of the header data.

18. The article of claim 16, wherein the decompression shell includes instructions to decompress the compressed memory image.

19. A system comprising:
a bus;
a display coupled to the bus;
a system memory coupled to the bus;
a device memory coupled to the bus and containing compressed device instructions and decompression instructions; and
a processor coupled to the bus, the processor to execute additional instructions including:
copying the compressed device instructions and decompression instructions from the device memory into the system memory; and
executing the decompression instructions to decompress the device instructions into the system memory.

20. The system of claim 19, wherein the device comprises a computer peripheral device.

21. The system of claim 20, wherein the computer peripheral device is a graphics card.

22. A method comprising:
allocating memory space for a compressed instruction set and decompression instructions;
copying the compressed instruction set and the decompression instructions into the allocated memory;
executing the decompression instructions to decompress the instruction set; and
executing the instruction set.

23. The method of claim 22, wherein the instruction set is decompressed into the allocated memory space.

24. The method of claim 22, wherein the instruction set comprises a set of instructions to initialize and operate a device.

25. The method of claim 24, wherein the device comprises a graphics card.

26. A computer-readable medium having stored thereon a data structure comprising:
a header including at least a portion of header data from a read only memory image;
a compressed copy of the read only memory image; and
a decompression shell.

27. The computer-readable medium recited in claim 26, wherein the data structure further comprises a decompression shell entry point.

28. The computer-readable medium recited in claim 26, wherein the data structure further comprises a plurality of read-only memory headers.

29. A method comprising:
attaching a compressed read only memory image and header data copied from the read only memory image to a decompression shell.

30. The method of claim 29, further comprising:
using the decompression shell to decompress and load the payload.

31. The method of claim 29, wherein the decompression shell comprises decompression code.

32. The method of claim 29, wherein the decompression shell comprises a decompression shell entry point.
